(19) United States
(12) Patent Application Publication
(10) Pub. No.: US 2024/0264959 A1
(43) Pub. Date: Aug. 8, 2024

(54) DOORBELL REGISTER INJECTION RATE MANAGEMENT

(71) Applicants: Jackson L. Ellis, Fort Collins, CO (US); Eliel Louzoun, Jerusalem (IL); Jose Santiago Niell, Franklin, MA (US); Alon Meir, Jerusalem (IL)

(72) Inventors: Jackson L. Ellis, Fort Collins, CO (US); Eliel Louzoun, Jerusalem (IL); Jose Santiago Niell, Franklin, MA (US); Alon Meir, Jerusalem (IL)

(21) Appl. No.: 18/622,308

(22) Filed: Mar. 29, 2024

(51) Int. Cl. G06F 13/20

(52) U.S. Cl. CPC G06F 13/20; G06F 2213/40

(57) ABSTRACT

A network interface device executes an input/output (I/O) virtualization manager to identify a virtual device defined to include resources of a particular virtual functions in a plurality of virtual functions associated with a physical function of a device. An operation is identified to be performed between the virtual device and a system image hosted by a host system coupled to the network interface device. The network interface device emulates the virtual device in the operation using the I/O virtualization manager.

### FIELD

The present disclosure relates in general to the field of distributed computing systems, and more specifically, to I/O virtualization.

### BACKGROUND

A datacenter may include one or more platforms each comprising at least one processor and associated memory modules. Each platform of the datacenter may facilitate the performance of any suitable number of processes associated with various applications running on the platform. These processes may be performed by the processors and other associated logic of the platforms. Each platform may additionally include I/O controllers, such as network adapter devices, which may be used to send and receive data on a network for use by the various applications.

Some platforms make use of I/O virtualization in order to improve datacenter performance. Single Root I/O Virtualization (SR-IOV) and Sharing specification, version 1.0 (2007) by the Peripheral Component Interconnect (PCI) Special Interest Group (PCI-SIG), provided hardware-assisted high performance I/O virtualization and sharing of PCI Express devices. Intel® Scalable IOV (SIOV) and Application Defined Infrastructure (ADI) are additional input/output (I/O) virtualization specifications that may serve to markedly expands current Peripheral Component Interconnect Express (PCIe) device number limitations to increase a number of containers or services that can utilize a PCIe device.

### BRIEF DESCRIPTION OF THE DRAWINGS

FIG. 1 illustrates a block diagram of components of a datacenter in accordance with certain embodiments.

FIG. 2 is a simplified block diagram of an example system implementing I/O virtualization.

FIG. 3 is a simplified block diagram illustrating an example computing system.

FIG. 4 is a simplified block diagram illustrating an example SR-IOV capable device.

FIG. 5 is a simplified block diagram of an example system including one or more I/O devices.

FIG. 6 is a simplified block diagram of an example I/O device coupled to a host device.

FIG. 7 is a simplified flow diagram illustrating an example technique for monitoring a logger queue in an I/O device in accordance with certain embodiments.

FIG. 8 illustrates a block diagram of an example processor device in accordance with certain embodiments.

Like reference numbers and designations in the various drawings indicate like elements.

### DETAILED DESCRIPTION

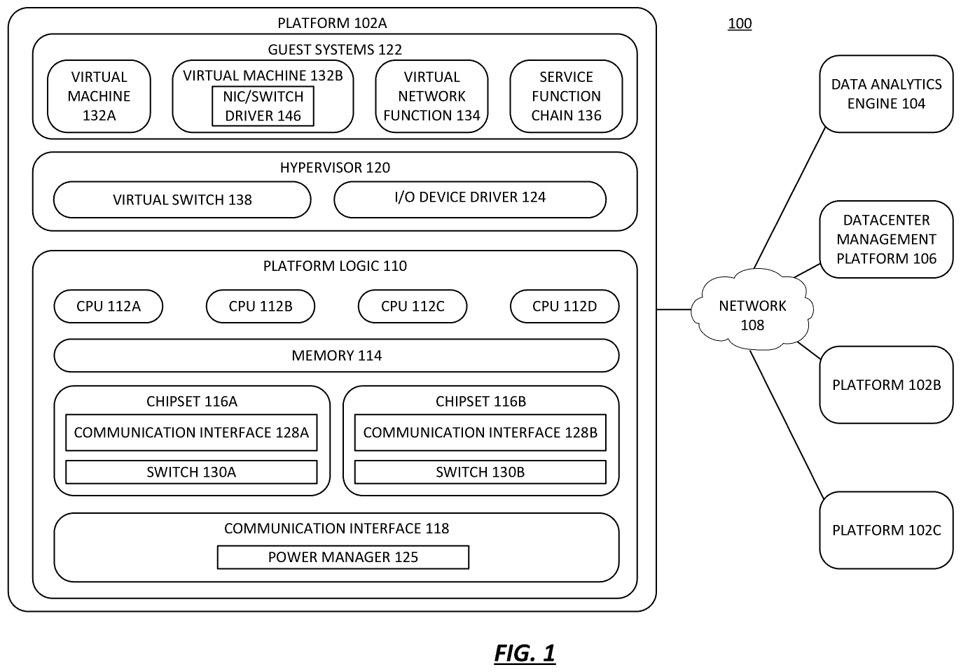

FIG. 1 illustrates a block diagram of components of a datacenter 100 in accordance with certain embodiments. In the embodiment depicted, datacenter 100 includes a plurality of platforms 102, data analytics engine 104, and datacenter management platform 106 coupled together through network 108. A platform 102 may include platform logic 110 with one or more central processing units (CPUs) 112, memories 114 (which may include any number of different modules), chipsets 116, communication interfaces 118, and any other suitable hardware and/or software to execute a hypervisor 120 or other operating system capable of executing processes associated with applications running on platform 102. In some embodiments, a platform 102 may function as a host platform for one or more guest systems 122 that invoke these applications. The platform may be logically or physically subdivided into clusters and these clusters may be enhanced through specialized networking accelerators and the use of Compute Express Link (CXL) memory semantics to make such cluster more efficient, among other example enhancements.

A platform 102 may include platform logic 110. Platform logic 110 comprises, among other logic enabling the functionality of platform 102, one or more CPUs 112, memory 114, one or more chipsets 116, and communication interface 118. Although three platforms are illustrated, datacenter 100 may include any suitable number of platforms. In various embodiments, a platform 102 may reside on a circuit board that is installed in a chassis, rack, compossible servers, disaggregated servers, or other suitable structures that comprises multiple platforms coupled together through network 108 (which may comprise, e.g., a rack or backplane switch).

CPUs 112 may comprise any suitable number of processor cores. The cores may be coupled to each other, to memory 114, to at least one chipset 116, and/or to communication interface 118, through one or more controllers residing on CPU 112 and/or chipset 116. In particular embodiments, a CPU 112 is embodied within a socket that is permanently or removeably coupled to platform 102. Although four CPUs are shown, a platform 102 may include any suitable number of CPUs. In some implementations, application to be executed using the CPU (or other processors) may include physical layer management applications, which may enable customized software-based configuration of the physical layer of one or more interconnect used to couple the CPU (or related processor devices) to one or more other devices in a data center system.

Memory 114 may comprise any form of volatile or non-volatile memory including, without limitation, magnetic media (e.g., one or more tape drives), optical media, random access memory (RAM), read-only memory (ROM), flash memory, removable media, or any other suitable local or remote memory component or components. Memory 114 may be used for short, medium, and/or long-term storage by platform 102. Memory 114 may store any suitable data or information utilized by platform logic 110, including software embedded in a computer readable medium, and/or encoded logic incorporated in hardware or otherwise stored (e.g., firmware). Memory 114 may store data that is used by cores of CPUs 112. In some embodiments, memory 114 may also comprise storage for instructions that may be executed by the cores of CPUs 112 or other processing elements (e.g., logic resident on chipsets 116) to provide functionality associated with components of platform logic 110. Additionally or alternatively, chipsets 116 may comprise memory that may have any of the characteristics described herein with respect to memory 114. Memory 114 may also store the results and/or intermediate results of the various calculations and determinations performed by CPUs 112 or processing elements on chipsets 116. In various embodiments, memory 114 may comprise one or more modules of system memory coupled to the CPUs through memory controllers (which may be external to or integrated with CPUs 112). In various embodiments, one or more particular modules of memory 114 may be dedicated to a particular CPU 112 or other processing device or may be shared across multiple CPUs 112 or other processing devices.

A platform 102 may also include one or more chipsets 116 comprising any suitable logic to support the operation of the CPUs 112. In various embodiments, chipset 116 may reside on the same package as a CPU 112 or on one or more different packages. A chipset may support any suitable number of CPUs 112. A chipset 116 may also include one or more controllers to couple other components of platform logic 110 (e.g., communication interface 118 or memory 114) to one or more CPUs. Additionally or alternatively, the CPUs 112 may include integrated controllers. For example, communication interface 118 could be coupled directly to CPUs 112 via integrated I/O controllers resident on the respective CPUs.

Chipsets 116 may include one or more communication interfaces 128. Communication interface 128 may be used for the communication of signaling and/or data between chipset 116 and one or more I/O devices, one or more networks 108, and/or one or more devices coupled to network 108 (e.g., datacenter management platform 106 or data analytics engine 104). For example, communication interface 128 may be used to send and receive network traffic such as data packets. In a particular embodiment, communication interface 128 may be implemented through one or more I/O controllers, such as one or more physical network interface controllers (NICs), also known as network interface cards or network adapters. An I/O controller may include electronic circuitry to communicate using any suitable physical layer and data link layer standard such as Ethernet (e.g., as defined by an IEEE 802.3 standard), Fibre Channel, InfiniBand, Wi-Fi, or other suitable standard. An I/O controller may include one or more physical ports that may couple to a cable (e.g., an Ethernet cable). An I/O controller may enable communication between any suitable element of chipset 116 (e.g., switch 130) and another device coupled to network 108. In some embodiments, network 108 may comprise a switch with bridging and/or routing functions that is external to the platform 102 and operable to couple various I/O controllers (e.g., NICs) distributed throughout the datacenter 100 (e.g., on different platforms) to each other. In various embodiments an I/O controller may be integrated with the chipset (i.e., may be on the same integrated circuit or circuit board as the rest of the chipset logic) or may be on a different integrated circuit or circuit board that is electromechanically coupled to the chipset. In some embodiments, communication interface 128 may also allow I/O devices integrated with or external to the platform (e.g., disk drives, other NICs, etc.) to communicate with the CPU cores.

Switch 130 may couple to various ports (e.g., provided by NICs) of communication interface 128 and may switch data between these ports and various components of chipset 116 according to one or more link or interconnect protocols, such as Peripheral Component Interconnect Express (PCIe), Compute Express Link (CXL), HyperTransport, GenZ, OpenCAPI, and others, which may each alternatively or collectively apply the general principles and/or specific features discussed herein. Switch 130 may be a physical or virtual (i.e., software) switch.

Platform logic 110 may include an additional communication interface 118. Similar to communication interface 128, communication interface 118 may be used for the communication of signaling and/or data between platform logic 110 and one or more networks 108 and one or more devices coupled to the network 108. For example, communication interface 118 may be used to send and receive network traffic such as data packets. In a particular embodiment, communication interface 118 comprises one or more physical I/O controllers (e.g., NICs). These NICs may enable communication between any suitable element of platform logic 110 (e.g., CPUs 112) and another device coupled to network 108 (e.g., elements of other platforms or remote nodes coupled to network 108 through one or more networks). In particular embodiments, communication interface 118 may allow devices external to the platform (e.g., disk drives, other NICs, etc.) to communicate with the CPU cores. In various embodiments, NICs of communication interface 118 may be coupled to the CPUs through I/O controllers (which may be external to or integrated with CPUs 112). Further, as discussed herein, I/O controllers may include a power manager 125 to implement power consumption management functionality at the I/O controller (e.g., by automatically implementing power savings at one or more interfaces of the communication interface 118 (e.g., a PCIe interface coupling a NIC to another element of the system), among other example features.

Platform logic 110 may receive and perform any suitable types of processing requests. A processing request may include any request to utilize one or more resources of platform logic 110, such as one or more cores or associated logic. For example, a processing request may comprise a processor core interrupt; a request to instantiate a software component, such as an I/O device driver 124 or virtual machine 132; a request to process a network packet received from a virtual machine 132 or device external to platform 102 (such as a network node coupled to network 108); a request to execute a workload (e.g., process or thread) associated with a virtual machine 132, application running on platform 102, hypervisor 120 or other operating system running on platform 102; or other suitable request.

In various embodiments, processing requests may be associated with guest systems 122. A guest system may comprise a single virtual machine (e.g., virtual machine 132a or 132b) or multiple virtual machines operating together (e.g., a virtual network function (VNF) 134 or a service function chain (SFC) 136). As depicted, various embodiments may include a variety of types of guest systems 122 present on the same platform 102.

A virtual machine 132 may emulate a computer system with its own dedicated hardware. A virtual machine 132 may run a guest operating system on top of the hypervisor 120. The components of platform logic 110 (e.g., CPUs 112, memory 114, chipset 116, and communication interface 118) may be virtualized such that it appears to the guest operating system that the virtual machine 132 has its own dedicated components.

A virtual machine 132 may include a virtualized NIC (vNIC), which is used by the virtual machine as its network interface. A vNIC may be assigned a media access control (MAC) address, thus allowing multiple virtual machines 132 to be individually addressable in a network.

In some embodiments, a virtual machine 132b may be paravirtualized. For example, the virtual machine 132b may include augmented drivers (e.g., drivers that provide higher performance or have higher bandwidth interfaces to underlying resources or capabilities provided by the hypervisor 120). For example, an augmented driver may have a faster interface to underlying virtual switch 138 for higher network performance as compared to default drivers.

VNF 134 may comprise a software implementation of a functional building block with defined interfaces and behavior that can be deployed in a virtualized infrastructure. In particular embodiments, a VNF 134 may include one or more virtual machines 132 that collectively provide specific functionalities (e.g., wide area network (WAN) optimization, virtual private network (VPN) termination, firewall operations, load-balancing operations, security functions, etc.). A VNF 134 running on platform logic 110 may provide the same functionality as traditional network components implemented through dedicated hardware. For example, a VNF 134 may include components to perform any suitable NFV workloads, such as virtualized Evolved Packet Core (vEPC) components, Mobility Management Entities, 3rd Generation Partnership Project (3GPP) control and data plane components, etc.

SFC 136 is group of VNFs 134 organized as a chain to perform a series of operations, such as network packet processing operations. Service function chaining may provide the ability to define an ordered list of network services (e.g., firewalls, load balancers) that are stitched together in the network to create a service chain.

A hypervisor 120 (also known as a virtual machine monitor) may comprise logic to create and run guest systems 122. The hypervisor 120 may present guest operating systems run by virtual machines with a virtual operating platform (i.e., it appears to the virtual machines that they are running on separate physical nodes when they are actually consolidated onto a single hardware platform) and manage the execution of the guest operating systems by platform logic 110. Services of hypervisor 120 may be provided by virtualizing in software or through hardware assisted resources that require minimal software intervention, or both. Multiple instances of a variety of guest operating systems may be managed by the hypervisor 120. A platform 102 may have a separate instantiation of a hypervisor 120.

Hypervisor 120 may be a native or bare-metal hypervisor that runs directly on platform logic 110 to control the platform logic and manage the guest operating systems. Alternatively, hypervisor 120 may be a hosted hypervisor that runs on a host operating system and abstracts the guest operating systems from the host operating system. Various embodiments may include one or more non-virtualized platforms 102, in which case any suitable characteristics or functions of hypervisor 120 described herein may apply to an operating system of the non-virtualized platform. Further implementations may be supported, such as set forth above, for enhanced I/O virtualization. A host operating system may identify conditions and configurations of a system and determine that features (e.g., SIOV-based virtualization of SR-IOV-based devices) may be enabled or disabled and may utilize corresponding application programming interfaces (APIs) to send and receive information pertaining to such enabling or disabling, among other example features.

Hypervisor 120 may include a virtual switch 138 that may provide virtual switching and/or routing functions to virtual machines of guest systems 122. The virtual switch 138 may comprise a logical switching fabric that couples the vNICs of the virtual machines 132 to each other, thus creating a virtual network through which virtual machines may communicate with each other. Virtual switch 138 may also be coupled to one or more networks (e.g., network 108) via physical NICs of communication interface 118 so as to allow communication between virtual machines 132 and one or more network nodes external to platform 102 (e.g., a virtual machine running on a different platform 102 or a node that is coupled to platform 102 through the Internet or other network). Virtual switch 138 may comprise a software element that is executed using components of platform logic 110. In various embodiments, hypervisor 120 may be in communication with any suitable entity (e.g., a SDN controller) which may cause hypervisor 120 to reconfigure the parameters of virtual switch 138 in response to changing conditions in platform 102 (e.g., the addition or deletion of virtual machines 132 or identification of optimizations that may be made to enhance performance of the platform).

Hypervisor 120 may include any suitable number of I/O device drivers 124. I/O device driver 124 represents one or more software components that allow the hypervisor 120 to communicate with a physical I/O device. In various embodiments, the underlying physical I/O device may be coupled to any of CPUs 112 and may send data to CPUs 112 and receive data from CPUs 112. The underlying I/O device may utilize any suitable communication protocol, such as PCI, PCIe, Universal Serial Bus (USB), Serial Attached SCSI (SAS), Serial ATA (SATA), InfiniBand, Fibre Channel, an IEEE 802.3 protocol, an IEEE 802.11 protocol, or other current or future signaling protocol.

The underlying I/O device may include one or more ports operable to communicate with cores of the CPUs 112. In one example, the underlying I/O device is a physical NIC or physical switch. For example, in one embodiment, the underlying I/O device of I/O device driver 124 is a NIC of communication interface 118 having multiple ports (e.g., Ethernet ports). In some implementations, I/O virtualization may be supported within the system and utilize the techniques described in more detail below. I/O devices may support I/O virtualization based on SR-IOV, SIOV, among other example techniques and technologies.

In other embodiments, underlying I/O devices may include any suitable device capable of transferring data to and receiving data from CPUs 112, such as an audio/video (A/V) device controller (e.g., a graphics accelerator or audio controller); a data storage device controller, such as a flash memory device, magnetic storage disk, or optical storage disk controller; a wireless transceiver; a network processor; or a controller for another input device such as a monitor, printer, mouse, keyboard, or scanner; or other suitable device.

In various embodiments, when a processing request is received, the I/O device driver 124 or the underlying I/O device may send an interrupt (such as a message signaled interrupt) to any of the cores of the platform logic 110. For example, the I/O device driver 124 may send an interrupt to a core that is selected to perform an operation (e.g., on behalf of a virtual machine 132 or a process of an application). Before the interrupt is delivered to the core, incoming data (e.g., network packets) destined for the core might be cached at the underlying I/O device and/or an I/O block associated with the CPU 112 of the core. In some embodiments, the I/O device driver 124 may configure the underlying I/O device with instructions regarding where to send interrupts.

In some embodiments, as workloads are distributed among the cores, the hypervisor 120 may steer a greater number of workloads to the higher performing cores than the lower performing cores. In certain instances, cores that are exhibiting problems such as overheating or heavy loads may be given less tasks than other cores or avoided altogether (at least temporarily). Workloads associated with applications, services, containers, and/or virtual machines 132 can be balanced across cores using network load and traffic patterns rather than just CPU and memory utilization metrics.

The elements of platform logic 110 may be coupled together in any suitable manner. For example, a bus may couple any of the components together. A bus may include any known interconnect, such as a multi-drop bus, a mesh interconnect, a ring interconnect, a point-to-point interconnect, a serial interconnect, a parallel bus, a coherent (e.g., cache coherent) bus, a layered protocol architecture, a differential bus, or a Gunning transceiver logic (GTL) bus.

Elements of the data system 100 may be coupled together in any suitable, manner such as through one or more networks 108. A network 108 may be any suitable network or combination of one or more networks operating using one or more suitable networking protocols. A network may represent a series of nodes, points, and interconnected communication paths for receiving and transmitting packets of information that propagate through a communication system. For example, a network may include one or more firewalls, routers, switches, security appliances, antivirus servers, or other useful network devices. A network offers communicative interfaces between sources and/or hosts, and may comprise any local area network (LAN), wireless local area network (WLAN), metropolitan area network (MAN), Intranet, Extranet, Internet, wide area network (WAN), virtual private network (VPN), cellular network, or any other appropriate architecture or system that facilitates communications in a network environment. A network can comprise any number of hardware or software elements coupled to (and in communication with) each other through a communications medium. In various embodiments, guest systems 122 may communicate with nodes that are external to the datacenter 100 through network 108.

Single Root I/O Virtualization (SR-IOV) is a PCI-SIG defined specification for hardware-assisted I/O virtualization that defines a standard way for partitioning endpoint devices for direct sharing across multiple VMs or containers. An SR-IOV capable endpoint device provides a Physical Function (PF) and multiple Virtual Functions (VFs). The PF of a device in SR-IOV provides resource management for the device and is managed by a host driver running in the host operating system (OS). A provided VF can be assigned to a VM or container for direct access. SR-IOV-capable devices may provide high performance I/O, including I/O devices such as network and storage controller devices as well as programmable or reconfigurable devices such as GPUs, FPGAs, and other accelerators, among other examples.

Scalable IOV (SIOV) also seeks to define an approach for the virtualization of I/O, for instance, within a data center. SIOV provides hardware-assisted I/O virtualization that enables a higher degree of scalability and performance in the sharing of I/O devices across isolated domains (e.g., VMs and containers). In SIOV, flexible composition of virtual devices for device sharing is enabled. Accesses between a VM and a virtual device are defined in SIOV as either a “direct path” access or an “intercepted path” access. Direct-path operations on the virtual device are mapped directly to the underlying device hardware for performance, while intercepted-path operations are emulated at least partially in software by a Virtual Device Composition Module (VDCM) to enable this greater flexibility in I/O virtualization. Which operations and accesses are processed as intercepted path versus direct path may vary depending on the device implementation and application. For instance, slow-path operations (e.g., initialization, control, configuration, management, QoS, error processing, and reset) are treated as intercepted-path accesses and fast-path operations (e.g., work submission and work completion processing) are treated as direct-path accesses, among other examples.

Similar to SR-IOV, resources of a given physical device may be mapped to individual VMs. In SIOV, a more customizable and granular approach is adopted, with SIOV enabling the flexible definition of virtual devices (VDEV) that may be mapped to a respective VM. High performance I/O devices may include a large number of command/completion interfaces for efficient multiplexing/demultiplexing of I/O. SIOV platforms may enable the assignment of such interfaces to isolated domains at a fine granularity. An SIOV architecture defines the granularity of sharing of a device or device resource as an “Assignable Device Interface” (ADI). Each ADI instance on the device may encompass the set of resources on the device that are allocated by software to support the direct-path operations for a virtual device. For instance, resources on a device associated with work submission, execution, and completion operations may implement device backend resources (e.g., command/status registers, on-device queues, references to in-memory queues, local memory on the device, or any other device-specific internal constructs). An ADI may identify a set (e.g., all or a subset of the total device resources, or even a combination of resources of two or more discrete devices) of device backend resources that are allocated, configured, and organized as an isolated unit, forming the unit of device sharing. The type and number of backend resources grouped to compose an ADI may be device specific. Each SIOV ADI on a device function may use the same PCIe Requester ID (Bus/Device/Function (BDF) number) corresponding to the device's PCIe Function. Process Address Space Identifiers (PASID) may be used to distinguish upstream memory transactions performed for different ADIs and to convey the address space targeted by the transaction.

ADIs form the unit of assignment and isolation for devices and are composed by software to form virtual devices (VDEVs). A Virtual Device Composition Module (VDCM) is responsible for managing virtual device instances. For instance, for direct-path accesses, a VMM may map the direct-path accesses from the guest directly onto the provisioned ADIs for the VDEV. For intercepted-path accesses, the VMM identifies the intercepted-path accesses from the guest and forwards them to VDCM for emulation. VDCM emulates the intercepted accesses to the VDEV. In some cases, the VDCM may access the underlying physical device corresponding to the ADI (e.g., to read a corresponding device register, identify ADI status, configure the ADI's PASID, etc.). Virtual device composition, among other advantages, enables increased sharing scalability and flexibility at lower hardware cost and complexity. SIOV utilizes software to define and share device resources with different address domains using different VDEV abstractions. For example, application processes may access a device using system calls and VMs may access a device using virtual device interfaces. Virtual device composition can also enable dynamic mapping of VDEVs to device resources, allowing a VMM to over-provision device resources to VMs. For instance, the resources of one or multiple physical devices may be mapped to a given VDEV. VDEVs may thus be defined to achieve particular goals of the system. As an example, in a data center with various physical machines containing different generations (e.g., versions) of the same I/O device, VDEVs may be defined to present the same VDEV capabilities irrespective of the different generations of physical I/O devices used in the VDEV definitions. Such a solution may allow the same guest OS image with a particular VDEV driver to be deployed or migrated to various combinations or deployments of physical machines.

During operation, upstream memory requests from all ADIs (within respective VDEV mapped to various VMs or containers) may be tagged with the Requester ID of the device (or device function) hosting the ADIs. Requests from different ADIs of the device function may be distinguished using a Process Address Space Identifier (PASID). The Requester ID and/or the PASID may be used to identify (e.g., in a TLP prefix) the address space associated with the request. Accordingly, when assigning an ADI to an address domain (e.g., VM, container, or process), the ADI may be configured with a unique PASID of the address domain and its memory requests may be tagged with the PASID value (e.g., in a PASID TLP Prefix).

As introduced above, in SIOV, a VDEV may serve as the abstraction through which a shared physical device is exposed to guest software. In some implementations, a VDEV may be exposed to a guest OS as a virtual PCI Express device. A VDEV may be defined to possess virtual resources such as virtual Requester ID, virtual configuration space registers, virtual memory BARs, virtual MSI-X table, etc. Each VDEV may be mapped to or formed from one or more ADIs (corresponding to various devices or device functions). The ADIs backing a VDEV may belong to the same physical function or allocated across multiple functions (e.g., to support device fault tolerance or load balancing).

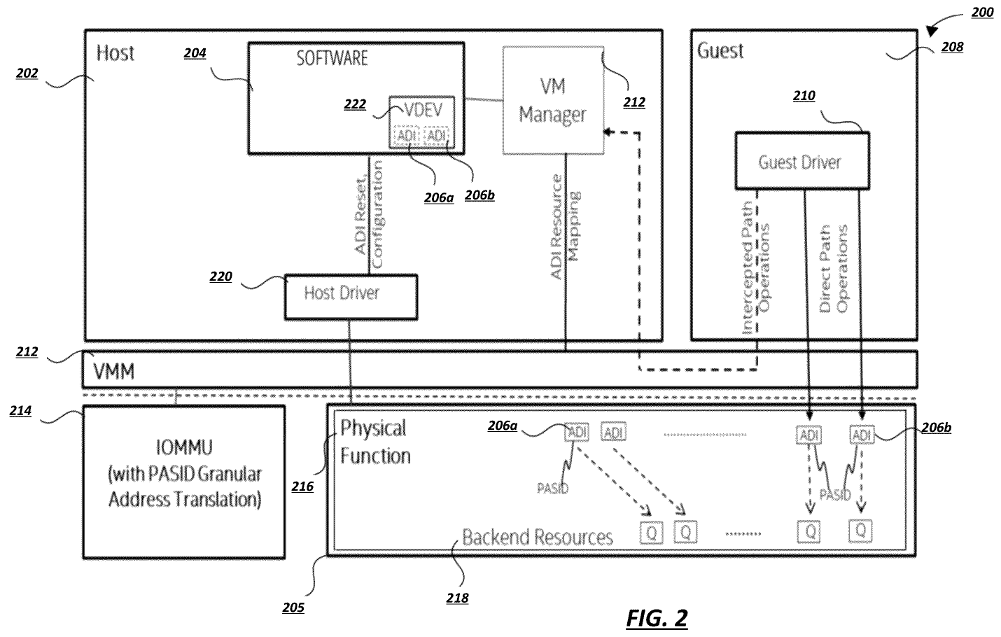

FIG. 2 is a simplified block diagram 200 illustrating an implementation of an example operating environment 200 that supports the SIOV architecture to virtualize one or more devices (e.g., 205) such as component devices on a given computing platform or other packages, such as accelerators, I/O devices, network processing devices, etc. Such an environment may be adapted to incorporate the features and functionality discussed herein. In this example, the operating environment may include a host OS 202, a guest OS 208, a VMM 212, an input/output memory management unit (IOMMU) 214, and one or more devices (e.g., 205) possessing I/O resources capable of being virtualized (e.g., based on SR-IOV or SIOV, etc.). Host OS 202, guest OS 208, and/or VMM 212 may execute on the host hardware 104. Host OS 202 may include a host driver 220 and guest OS 208 may include a guest driver 210.

As shown, in SIOV environments, host OS 202 may include software 204 which may compose a virtual device (VDEV) 222 for the guest OS 208. In some embodiments, VDEV 222 may include virtual capability registers configured to expose device (or “device-specific”) capabilities to one or more components of operating environment 200. In various embodiments, virtual capability registers may be accessed by guest driver 210 of the device 205 to determine device capabilities associated with VDEV 222. The VDEV 222 may include one or more assignable device interfaces (ADIs) (also referred to as “assignable interfaces”), including an ADI 206a and an ADI 206b. In some embodiments, an ADI may be assigned, for instance, by mapping the ADIs 206a-206b into a MMIO space of the VDEV 222. An ADI generally refers to the set of backend resources 218 of the device 205 that are allocated, configured, and organized as an isolated unit, forming the unit of device sharing of the device 205. The type and number of backend resources 218 grouped to compose a given ADI 206a, 206b, may be specific to the device 205. An ADI 206a, 206b may be associated with a device context, rather than with specific device resources. As another example, the backend resources 218 of the ADIs 206a-206b may include one or more shared work queues. A repository (not pictured) or other data structure may store a plurality of different ADIs and the respective attributes of each ADI.

For example, if the device 205 is a network controller, the ADIs 206a-206b may provide backend resources 218 that include transmit queues and receive queues associated with a virtual switch interface. As another example, if the device 205 is a storage device, the ADIs 206a-206b may provide backend resources 218 that include command queues and completion queues associated with a storage namespace. As yet another example, if the device 205 is a graphics processing unit (GPU), the ADIs 206a-206b may provide backend resources 218 that include dynamically created graphics or compute contexts, among other example devices and ADIs.

The IOMMU 214 may be configured to perform memory management operations, including address translations between virtual memory spaces and physical memory. As shown, the IOMMU 214 may support translations at the Process Address Space ID (PASID) level. Generally, a PASID may be assigned to each of a plurality of processes executing on the host hardware 104 (e.g., processes associated with guest OS 208 and/or VMs). Doing so enables sharing of the device 205 across multiple processes while providing each process a complete virtual address space.

In some implementations, software 204 may implement a VDCM. In some instances, a distinct instance of software 204 (or a VDCM) may be provided for each device which is to be virtualized. For instance, a VDCM may be implemented as a device-specific component responsible for composing and implementing VDEV instances 222 using one or more ADIs allocated, for instance, by a host driver 220. The VDCM implements software-based virtualization of intercepted-path operations and arranges for direct-path operations to be submitted directly to the backing ADIs. The host driver 220 may be loaded DCMs may be implemented and packaged by device vendors in a various ways, such as user-space modules or libraries that are installed as part of the host driver or a. In other implementations, the VDCM may be a kernel module. If implemented as a library, the VDCM may be statically or dynamically linked with the hypervisor-specific virtual machine resource manager responsible for creating and managing VM resources. If implemented in the host kernel, the VDCM can be part of the host driver. The host driver is loaded and executed as part of the host OS or hypervisor software. The host driver may report support for SIOV (and/or SR-IOV) to system software through the driver interface. In addition to traditional device driver functionality, the host driver 220 may implement software interfaces (e.g., as defined by the host OS or hypervisor infrastructure) to support enumeration, configuration, instantiation, and management of ADIs. The host driver may be responsible for configuring the ADIs, including aspects such as PASID identity, Interrupt Message Storage entries, MMIO register resources for direct-path access to the ADI, and any device-specific resources, among other example functionality and features. An SIOV compatible guest driver 210 may manage the VDEV instances composed by the VDCM. Direct-path accesses by the guest driver 210 may be issued directly to the ADIs (e.g., 206a-b) mapped to the VDEV, while intercepted-path accesses are intercepted and virtualized by the VDCM (e.g., 204). In some implementations, guest and host drivers can be implemented as a unified driver that supports both host and guest functionality or as two separate drivers. For existing SR-IOV devices, if the VDEV can be composed to behave like an existing VF, the Intel Scalable IOV guest driver can be same as the SR-IOV VF driver, among other examples.

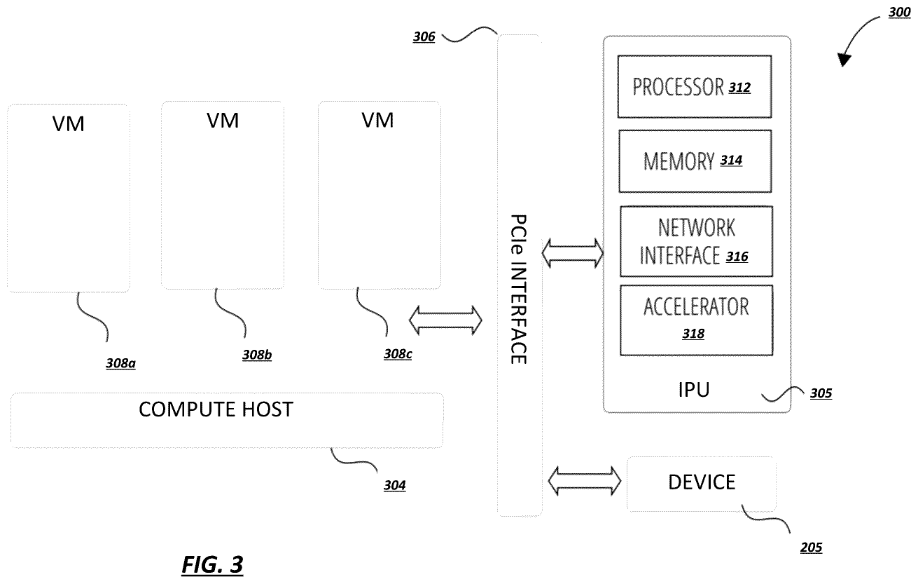

Turning to FIG. 3, a simplified block diagram 300 is shown illustrating an example network interface device 305, such as an infrastructure processing unit (IPU), smart network interface controller (smart NIC), an edge processing unit (EPU), or other networking device posing networking interfaces, networking circuitry, memory, and microcontroller (e.g., CPU). In this example, a network interface device 305 is coupled to host hardware 304, and a device 205 coupled via a PCIe interface 306. The network interface device 305, host hardware 104, device 205, and PCIe interface 306 may be implemented in circuitry. For example, the network interface device 305, host hardware 304, device 205, and PCIE interface 306 may be communicably coupled components of a compute node, server blade, server rack, or any other computing hardware. The host hardware 304 includes at least one processor circuit and memory (each not pictured). network interface device 305 also includes at least one processor 312, memory 314, an accelerator 318, and a network interface device 316 (e.g., a wired and/or wireless Ethernet network interface). The network interface device 316 may provide an interface to other devices via a network (e.g., a local area network (LAN), a wide area network (WAN), the Internet, etc.) and may support the Institute of Electrical and Electronics Engineers (IEEE) suite of Ethernet standards (e.g., 802.1, 802.3, etc.). The device 205 may be any type of peripheral device, such as a PCIe-compatible device. Although the PCIe interface 306 is used as a reference example of an interface, other interfaces may be used in the operating environment. For example, a Compute Express Link® (CXL) interface, a peripheral component interconnect (PCI), interface, a universal serial bus (USB) interface, a serial peripheral interconnect (SPI), an integrated interconnect (I2C), or a Universal Chiplet Interconnect Express (UCIe) interface may be used instead of the PCIe interface 306, among other examples. Therefore the device 205 may be a USB device, PCI device, PCIe device, CXL device, UCIe device, I2C, and/or an SPI device and provide I/O resources (e.g., for virtualization) in accordance with its corresponding I/O protocol or technology. The network interface device 305 further includes a direct memory access (DMA) engine to facilitate DMA transactions, among other example features.

The host hardware 304 may be representative of one or more processors and memory to execute one or more virtual machines (VMs), such as VM 308a, VM 308b, and VM 308c (or other containers or other isolated domains). The network interface device 305 includes one or more programmable or fixed function processors to perform offload of operations that could have been performed by processors of the host hardware 304. The network interface device 305 may therefore be considered as an “offload device.” More generally, the network interface device 305 may perform virtual switch operations, manage storage transactions (e.g., compression, cryptography, virtualization), and manage operations performed on other IPUs, compute nodes, servers, and/or devices. Indeed, an improved network interface device 305 may include SIOV and SR-IOV logic to allow SIOV functionality to be offloaded from the host to the network interface device 305 (e.g., the VDCM or other ADI management logic).

An example network interface device 305 may handle I/O, initialization, manage resources, implement security, error handling, quality of service (QoS) handling, and control. Conventionally, I/O, resources, security, and control may be performed by the host hardware 304. These functions include virtualization of devices, such as the device 205. The device 205 is representative of any type of device, such as a network interface device, accelerator device, storage device, and the like. Although depicted as external to the network interface device 305, in some embodiments, the device 205 may be a component of the network interface device 305. Similarly, although depicted as external to the host hardware 304, in some embodiments, the device 205 is a component of the host hardware 304, among other example implementations. In some implementations, the network interface device 305 may include I/O virtualization logic (implemented in hardware and/or software) to virtual aspects of the device 205. For instance, the device 205 may be virtualized by the network interface device 305 for the VMs 308a-308c based on the SIOV architecture. Similarly, the accelerator 318, network interface device 316, and other components (and device functions) of the network interface device 305 may be virtualized using the S-IOV architecture (e.g., with the device 205, network interface device 316, and the accelerator 318 being SIOV-compliant or compatible).

By outsourcing SIOV functionality from the host (e.g., the host kernel) to a network interface device (e.g., 305), host resources may be economized, additional security may be provided (e.g., through enhanced security capabilities implemented on the network interface device), and additional features and enhancements may be provided through the network interface device 305, among other example uses and advantages. For instance, VDEVs may be facilitated that includes multiple physical functions with the multiple physical functions may be provided by one or more devices 205 and/or components of the network interface device 305. Additionally, the network interface device 305 may also support SR-IOV and include SR-IOV-based physical functions and virtual functions. In some implementations, by provisioning the network interface device with SIOV logic (e.g., an I/O virtualization manager, ADI manager, VDCM, etc.), SR-IOV resources and functions may be mapped to SIOV ADIs to backport SIOV functionality to SR-IOV devices and functions, among other example applications.

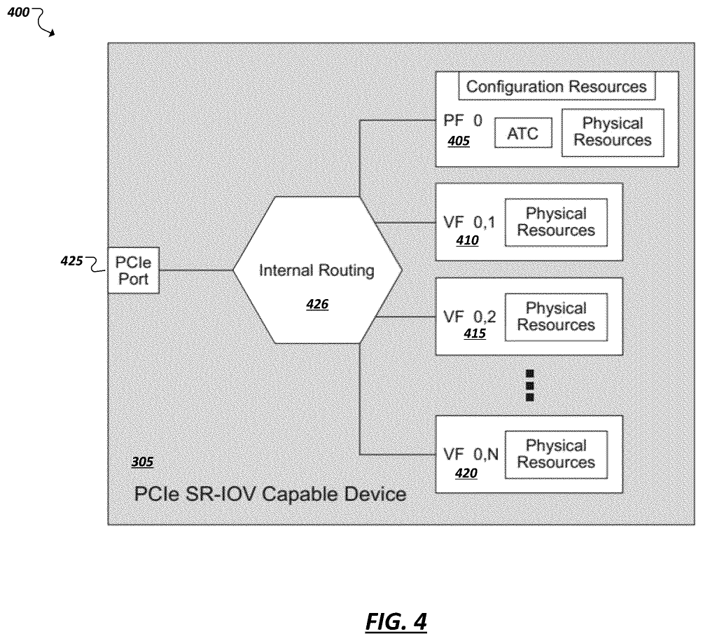

FIG. 4 is a simplified block diagram 400 showing an example SR-IOV device 305. A SR-IOV device (e.g., 305) may include one or more physical functions (PFs), with a PF (e.g., 405) having one or more (likely multiple) virtual functions (VF) (e.g., 410, 415, 420) associated with the PF 405. PFs are device functions (e.g., PCIe Functions) that support SR-IOV Extended Capability and VFs may be “lightweight” versions of the same function that may be directly accessible by an isolated domain (e.g., a container or VM). The VF may include its own resources (e.g., control registers, status registers, BAR registers, one or more interrupt message stores (IMS), and message-signaled interrupts (MSI-X)) associated with the main data movement of the function and these resources may be made available to an isolated domain that is assigned to the VF. A VF may be serially shared by different isolated domains (e.g., first assigned to one VM, then reset and assigned to a different VM, etc.). A VF associated with a respective PF has the same device type as the PF (e.g., the same network device type, same storage device type, same encryption device type, etc.). The SR-IOV device 305 shares common PCIe Link 425 (among the PF and VFs (e.g., using internal routing circuitry 426)). The Link and PCIe functionality shared by all Functions on the device 305 may be managed through Physical Function 0 (e.g., 405). A PCIe Function has a set of unique physical resources including a separate configuration space and BAR. A VF, however, shares some other resources with its associated PF, such as sharing a number of common configuration space fields with the PF, using the same configuration mechanisms and header types as a PF, etc. The associated SR-IOV extended capability register may be programmed to define the or identify the maximum number of VFs that can be associated with a given PF on the device 305. Each Function, PF, and VF may be assigned a unique Routing ID. The Routing ID for each VF may be defined using the Routing ID of its associated PF and fields in that PF's SR-IOV Extended Capability. The non-shared set of physical resources of a VF are resources used to deliver Function-specific services, (e.g., resources such as work queues, data buffers, etc.) to the isolated domain assigned. In some cases, a single address translation cache (ATC) (e.g., 430). While the example illustrated in FIG. 4 shows a single PF with multiple associated VFs, it should be appreciated that other SR-IOV devices may include multiple different PFs (of different device types), each with their own corresponding set of VFs, among other examples.

Modem cloud data centers are architected to service a multi-tenant environment, including virtual machines and containers, in which various applications, services, and microservices may be executed. I/O functions can be assigned to tenants using various methods like PCIe SR-IOV Virtual Functions (VFs) or Scalable IOV Assignable Device Interfaces (ADIs). Exposed device functions may include networking, compression, storage, cryptography, graphics, machine learning, or other acceleration technologies.

Traditionally, submitting work requests from a host system to I/O functions involved first writing a command or descriptor to a work queue (e.g., implemented as a circular buffer) in system memory, and then write an alert or notification pointer (a “doorbell” pointer), for instance, implemented as a tail pointer, written directly to the device implementing the I/O function (e.g., using a Memory Mapped IO (MMIO) register). Hardware associated with the I/O function would then use the “doorbell” tail pointer to identify an entry in the work queue and read corresponding available work entries in system memory to perform corresponding work.

While this traditional approach has largely proved effective in submitting and managing I/O function requests, I/O function hardware may have a limited doorbell processing rate. For instance, the doorbell processing rate may be limited by the complex mapping tables which translate Memory Mapped IO function addresses to a limited set of physical resources, among other example issues. As data center, cloud computing, and other architectures may provide for I/O function hardware that is shared concurrently by multiple different tenants, it is possible for one or more of the tenants (e.g., an individual client, application, process, or thread) to inject a high rate of doorbells to the I/O hardware at a rate or amount that exceeds the doorbell processing rate of the I/O hardware. As a result, this limitation allows one or more of the tenants to impact the performance of all other tenants also sharing a given virtualized hardware resource. For instance, were a single tenant to inject an overwhelming amount of doorbell pointers, this would cause other doorbell pointers issued by other tenants to potentially stall or be dropped. Accordingly, this limitation may result in the critical requirement of tenant isolation to be violated. Indeed, a malicious tenant could potentially inject a high amount of doorbell pointers to I/O function hardware for the purpose of disrupting a system, among other example issues. Additionally, modern CPU architectures are enhancing the rate of MMIO accesses with new acceleration technologies, such as non-temporal and non-block memory I/O memory writes. As these capabilities improve, the possibility of malicious tenants to trigger the problem increases. Also, in some implementations, the slow I/O function doorbell register address translation tables may be implemented prior to the design and development of corresponding hardware doorbell arbitration logic, which prevents solving the problem through priority arbitration algorithms, among other examples.

Traditional mechanisms for controlling and monitoring work requests are limited. For instance, a hardware mechanism close to a PCIe host interface may be provided to detect time windows where PCIe posted credits are running low. A counter may be provided (e.g., one counter per PCIe function) to count the number of MMIO writes per function. Such counters may be used in connection with monitoring posted credits to detect malicious virtual machines and take further actions like disabling the impacted functions. While such an approach may detect malicious SR-IOV functions because the SR-IOV functions have MMIO addresses assigned to a contiguous physical address range per function, such solutions do not scale to detect hardware assigned to SIOV ADIs, as SIOV ADI doorbell addresses may be scattered across the memory map. The PCIe host interface would not utilize SIOV doorbell mapping tables for any other reason. As a result, adding dedicated SIOV doorbell mapping tables are complex and expensive in silicon area. Further, relying on the monitoring of PCIe credits may be a deficient approach in that malicious or otherwise overwhelming doorbell requests are likely to be detected late once PCIe credits are starting to be depleted, among other example issues.

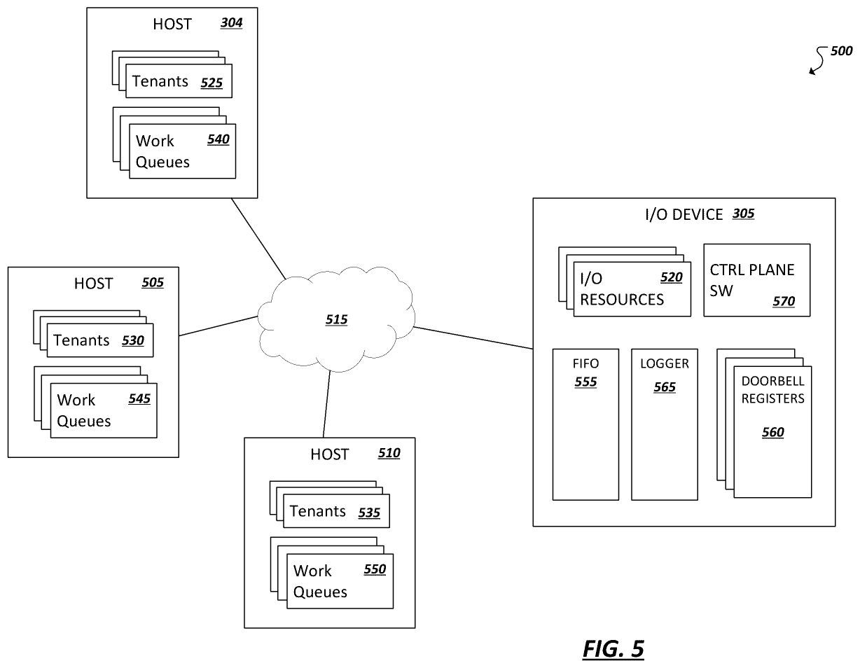

Turning to the simplified block diagram 500 of FIG. 5, in an improved example implementation, logic may be provided in an I/O device 305 (e.g., in an infrastructure processing unit (IPU), NIC, smart NIC, data processing unit (DPU), a device implementing one or more I/O functions (e.g., which may be virtualized), or other device which receives or forwards doorbell requests may be forwarded) to enable malicious or excessive doorbell rate detection for functions (e.g., NVMe device function) for both SR-IOV VFs and SIOV ADIs. The I/O device may provide I/O functions (e.g., virtualized I/O functions) associated with one or more I/O resources 520 (e.g., networking, storage, crypto, graphics, machine learning hardware, etc.) of the I/O device 305, which may be requested and utilized by various tenants (e.g., 525, 530, 535) on various host systems (e.g., 304, 505, 510). Tenants may be a utility which calls on and uses the I/O resources 520 of the I/O device 305, including functions, virtual machines, containers, processes, threads, etc. run on the host machines 304, 505, 510, etc. The host devices (e.g., 304, 505, 510) may be coupled to the I/O device 305 (and potentially other I/O devices) by an interconnect fabric 515, which may include point-to-point links (e.g., PCIe link, CXL links, UCIe links, etc.), switches, on-chip networks, and other interconnects.

A tenant 530 may submit a work request to be retrieved and completed use I/O resources of I/O device 305 within a work queue (e.g., 540, 545, 550) implemented in host memory. The I/O device 305 may access the host memory to read work requests and perform the corresponding tasks identified in the work request. To alert the I/O device 305 of the presence of a new work request in a work queue (e.g., 540) of a host (e.g., 304), the host or a tenant corresponding to the work request, may cause a doorbell pointer to be written to a doorbell register 560 of the I/O device 305 (e.g., using an MMIO register write). In some implementations, an I/O device 305 may include a single doorbell queue 560, while in other implementations, multiple doorbell queues 560 may be implemented (e.g., each doorbell queue corresponding to a respective function, I/O resource, service level, etc.). In some implementations, a queue 555 (e.g., a FIFO queue) may be implemented in memory of the I/O device 305 to buffer doorbell register writes, among other example features.

In one example, an I/O device (e.g., 305) may be equipped with logic to guard against the abuse of malicious or “greedy” tenants. Accordingly, some implementations of an I/O device may include hardware to implement a doorbell processing queue 555 (e.g., a first-in first-out (FIFO) queue) and may further include a software-controllable doorbell logging queue 556 (e.g., FIFO queue) in parallel with and mirroring the doorbell processing queue 555. Once the doorbell logging queue 565 reaches a configurable threshold (e.g., based on the amount or rate of doorbell pointers/requests received), the doorbell logging queue's state may be frozen and an interrupt generated to control plane software 570 of the I/O device to extract the contents of the doorbell logging queue 565 to determine whether and why the threshold has been met/exceeded. The frozen doorbell logging queue 565 serves as a snapshot capturing the state of the doorbell processing queue 555 that the doorbell logging queue is mirroring, without affecting the ongoing processing of doorbell requests in the processing queue. The extracted contents, or snapshot, of the doorbell logging queue, meanwhile, may be provided to control software 570 for inspection to detect which tenant (e.g., function or ADI) is injecting an overly aggressive or malicious rate of doorbells. Control software 570 may then act to mitigate the cause of the excessive doorbell writes, with more precision, to block or throttle doorbell requests from tenants responsible for injecting the overly high number or rate of doorbells and preserve the I/O functions' availability for other tenants in a multi-tenant system. Such functionality may provide value in detecting and isolating malicious VMs and containers in a multi-tenant system, among other example benefits.

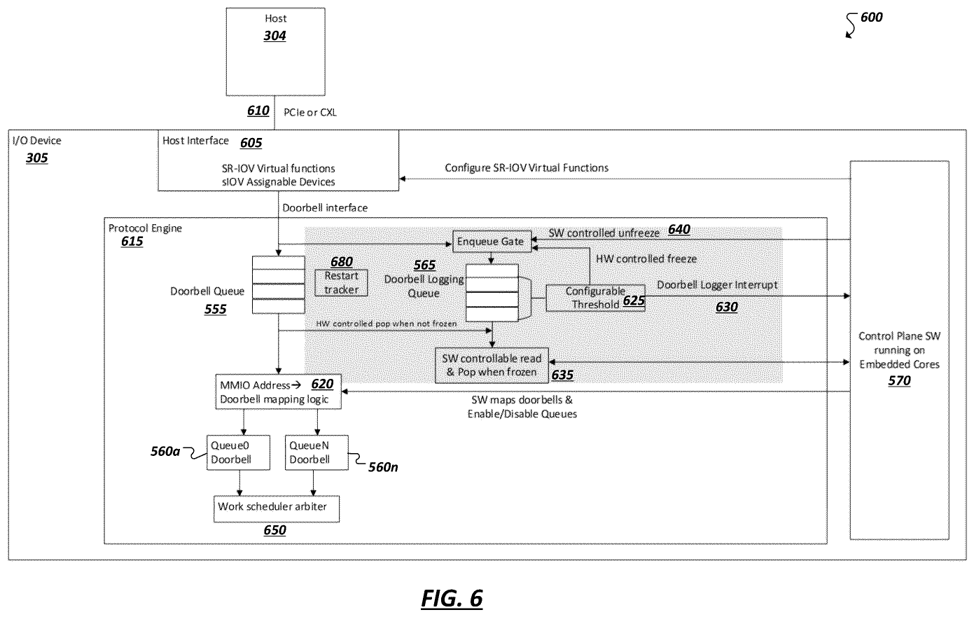

Turning to FIG. 6, a simplified block diagram 600 is shown illustrating an example implementation of doorbell management logic of an example I/O device (e.g., an IPU, smart NIC, or DPU). The I/O device (e.g., 305) may interface with one or more host devices (e.g., 304) over an interface 605 (implementing a link 610 (e.g., a PCIe- or CXL-compliant link)) over which data may be communicated at high speeds, including requests to write to one or more doorbell registers (e.g., 560a-n). A protocol engine 615 of the I/O device 305 may manage a doorbell queue 555 for the doorbell write (e.g., MMIO) requests received from the host 304 (e.g., from various tenants hosted by the host 304). In some implementations, a single doorbell register may be provided on the I/O device for all work requests submissions. In such instances, the doorbell queue and doorbell register may be one and the same. In other instances, multiple doorbell registers 560a-660n may be provided and a doorbell queue 555 (e.g., a FIFO queue) may be provided to buffer requests to any of the doorbell registers 560a-n. The doorbell requests may identify a specific doorbell register by its address and doorbell mapping logic 620 may cause the doorbell request to write a doorbell pointer to the identified doorbell register (e.g., one of doorbell register 560a-n). A work scheduler arbiter 650 may read the doorbell pointers within the doorbell register to identify a location in a work queue in memory of the host 304 and read the contents of this work queue location to determine the work that is to be performed (e.g., in connection with virtualization of one or more I/O resources of the I/O device on behalf of a virtual machine, application, thread, or other software executed on the host 304).

The doorbell logger queue 565 is a parallel structure to the hardware doorbell queue 555. The hardware doorbell queue 555 is configured to continuously run and not freeze. Accordingly, the standard doorbell queue 555 is to remain functional, even if a malicious doorbell rate is injected. During normal operation, the doorbell logger queue 565 is not frozen and operates in parallel/lock-step with the doorbell queue 555, with the two queues 555, 565 enqueued and popped at the same time (e.g., although the doorbell queue and doorbell logging queue may be different sizes). The doorbell logging queue has a configurable threshold 625 (e.g., configured via a configuration register). The threshold may be an amount of queue entries, a percentage of free capacity in the doorbell queue 555, a rate of requests received within the doorbell queue, among other example threshold metrics. Once the threshold is reached, logic within the protocol engine 615 freezes the doorbell logger queue 565 (e.g., such that the doorbell logger queue's contents are frozen in place, with no more enqueues or pops). However, even after the doorbell logger queue 565 is frozen, the doorbell queue 555 continues to function, with subsequent doorbell writes received from the host 304 continuing to queue within the doorbell queue 555.

In some implementations, when the doorbell logger queue 565 is frozen based on the configurable threshold 625 being met (or exceeded), an interrupt 630 may be generated to the control plane software 570 within the I/O device 305. The control plane software 570, in some implementations, may initiate the analysis of the contents of the doorbell logger queue (e.g., at the I/O device or by another system (e.g., by sending at least a portion of the contents of the frozen doorbell logger queue snapshot data to the other system for analysis). In one example, the control plane software may pop 635 the contents of the doorbell logger queue 565 through a register interface. Through inspection, the control plane software can identify which functions or ADIs are overwhelming the doorbell processing logic. For instance, queue contents (e.g., in both the doorbell queue and doorbell logger queue) may include tail bump addresses associated with various tenants, which may be used to determine which tenant perform the tail bump, among other example techniques. The control plane software 570 may, in some implementations, trigger mitigation measures to stop, slow, or other alleviate the excessive doorbell writes and may do so in a precise manner (e.g., targeting a specific function or ADI). For instance, the control plane software 570 can then additionally take actions to disable the malicious tenants such as unmapping the doorbells, disabling the queues, disabling the PCIe functions, or even coordinating (e.g., through communication over link 610 or a sideband interface) with the host 304 or host hypervisor to detach an ADI or other tenant, among other examples.

The control plane software 570 may determine (e.g., based on the doorbell logger being read, after an analysis process, or mitigation process has been initiated or completed) that the doorbell logger queue 565 may be unfrozen and resume logging in parallel with the doorbell queue (e.g., to produce a running copy of the doorbell queue's contents). The doorbell logger queue may be emptied (e.g., in connection with an analysis of the doorbell logger queue) and the control plane software 570 may use a register interface to unfreeze 640 the doorbell logger queue 565, which will then restart enqueuing new doorbells as they are written to the doorbell queue 555. In order to properly restart the doorbell logger queue, in some implementations, there is a restart tracker 680 which tracks when the newly enqueue entries in the doorbell logger queue have reached the head of the doorbell queue 555 and ensure that the doorbell logger queue 565 is producing an accurate copy of the contents of the doorbell queue (e.g., before the doorbell logger queue 565 is allowed to freeze again upon meeting the configurable threshold 635), among other example features.

Unlike counters, which may be utilized in some implementations, the logger queue, doorbell queue, and doorbell registers may be scaled in accordance with the scope of I/O functions, tenants, and associated policies. For instance, separate doorbell registers may be provided on a per-function or even per-tenant basis. Additionally, one or more multiple doorbell queues may be maintained and monitored using corresponding logger queues (e.g., to apply different thresholds or policies (e.g., service level agreement policies)) to different tenants, hosts, functions, or workloads, among other examples. Indeed, an I/O device may even utilize multiple protocol engine instances, based on the system architecture and policies that are desired to be enforced within the architecture, among other example features and implementations.

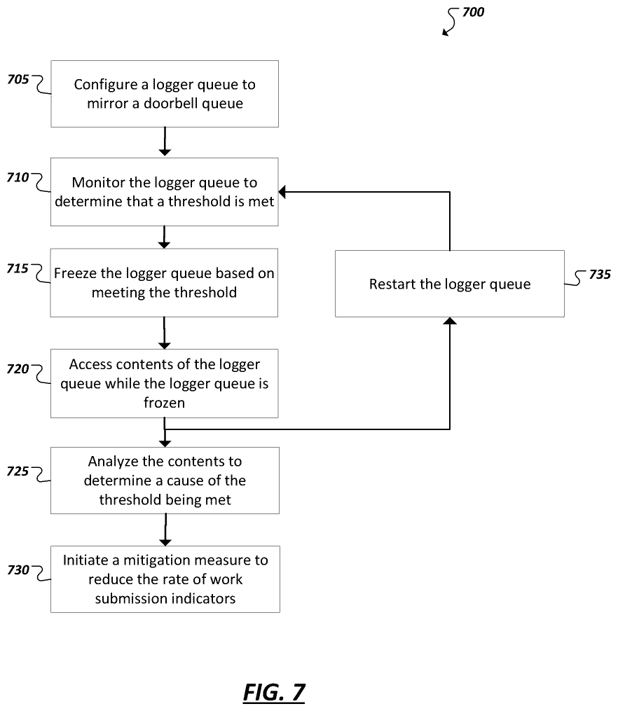

Turning to FIG. 7, a simplified flow diagram 700 is shown illustrating an example technique for managing doorbells in a doorbell queue of an I/O device. For instance, a software-based controller may configure 705 a logger queue in memory of the I/O device to mirror the doorbell queue, such that each doorbell, or work submission indicator, written to the doorbell queue is also written or copied to the logger queue. Configuration 705 of the logger queue may include the definition of one or more threshold amounts of work submission indicators copied to the logger queue, which, when met, are to cause the logger queue to freeze. The logger queue is monitored 710 (e.g., by hardware or software) to determine whether the configured threshold is met while the I/O device runs and work submission indicators are written to the doorbell queue (and logger queue). If the threshold is met (or exceeded) the logger queue is frozen 715, which allows the contents of the logger queue to be extracted, the contents represented a snapshot of the doorbell queue at the time the logger queue is frozen. The doorbell queue continues to accept doorbell writes from the one or more hosts coupled to the I/O device (e.g., via PCIe or CXL links) while the logger queue is frozen.

The contents of the frozen logger queue are accessed 720 or extracted from the logger queue for analysis by a software-based controller (e.g., on the I/O device or another computing device). This snapshot of the doorbell queue may be analyzed 725 to determine a cause for the threshold being met. The threshold may be configured to represent a condition where the doorbell queue is (likely) being overrun by work submission indicators (doorbells), such that the work submission indicators are being injected at a rate, which is faster than the I/O device's work handler is able to process the corresponding work requests. This may be evidence of a host tenant that is behaving maliciously, greedily, or otherwise in a manner that threatens the I/O device's ability to also handle other tenants' requests. In some instances, based on the determined cause of the threshold being met, the software-based controller may initiate 730 various appropriate mitigation measures to attempt to normalize (e.g., reduce) the rate of work submission indicator injections at the doorbell queue. Such mitigation measures may include unmapping a corresponding doorbell register, disabling a doorbell queue, disabling PCIe functions associated with an abusive tenant, and/or communicating with the host to cause the host to take actions to throttle or disable an abusive tenant, among other examples. When the contents of the frozen logger queue are accessed and analysis is initiated, the software controller may cause the logger queue to be restarted 735 so that the logger queue is emptied and begins again to collect, in lockstep with the doorbell queue, the latest work submission indicators being written to the doorbell queue, allowing subsequent instances of excessive doorbell injection rates to be detected and assessed, among other example features and implementations.

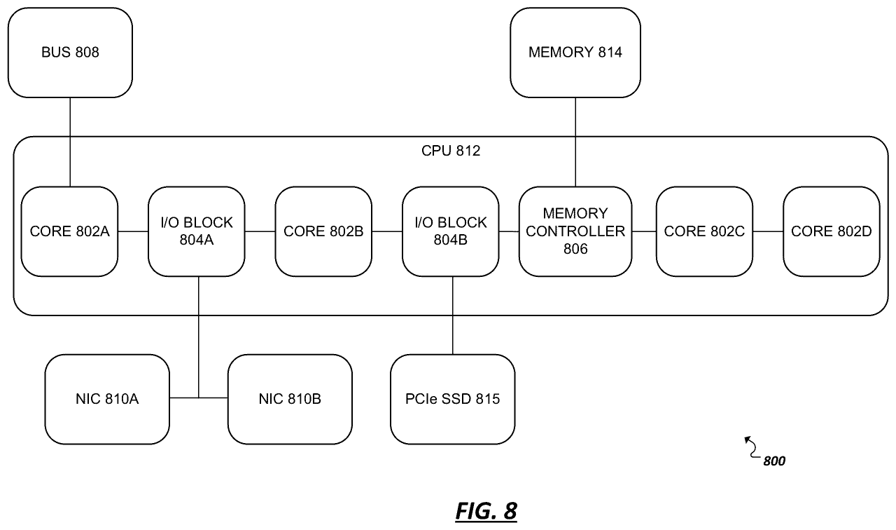

Note that the apparatus', methods', and systems described above may be implemented in any electronic device or system as aforementioned. As a specific illustration, FIG. 8 provides an exemplary implementation of a processing device such as one that may be included in a network interface device. It should be appreciated that other processor architectures may be provided to implement the functionality and processing of requests by an example network interface device, including the implementation of the example network interface device components and functionality discussed above. Further, while the examples discussed above focus on improvements to an Ethernet subsystem and links compliant with an Ethernet-based protocol, it should be appreciated that the principles discussed herein are protocol agnostic and may be applied to interconnects based on a variety of other technologies, such as PCIe, CXL, UCIe, CCIX, Infinity Fabric, among other examples.

Referring to FIG. 8, a block diagram 800 is shown of an example data processor device (e.g., a central processing unit (CPU)) 812 coupled to various other components of a platform in accordance with certain embodiments. Although CPU 812 depicts a particular configuration, the cores and other components of CPU 812 may be arranged in any suitable manner. CPU 812 may comprise any processor or processing device, such as a microprocessor, an embedded processor, a digital signal processor (DSP), a network processor, an application processor, a co-processor, a system on a chip (SOC), or other device to execute code. CPU 812, in the depicted embodiment, includes four processing elements (cores 802 in the depicted embodiment), which may include asymmetric processing elements or symmetric processing elements. However, CPU 812 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical CPU 812, as illustrated in FIG. 8, includes four cores-cores 802A, 802B, 802C, and 802D, though a CPU may include any suitable number of cores. Here, cores 802 may be considered symmetric cores. In another embodiment, cores may include one or more out-of-order processor cores or one or more in-order processor cores. However, cores 802 may be individually selected from any type of core, such as a native core, a software managed core, a core adapted to execute a native Instruction Set Architecture (ISA), a core adapted to execute a translated ISA, a co-designed core, or other known core. In a heterogeneous core environment (e.g., asymmetric cores), some form of translation, such as binary translation, may be utilized to schedule or execute code on one or both cores.

A core 802 may include a decode module coupled to a fetch unit to decode fetched elements. Fetch logic, in one embodiment, includes individual sequencers associated with thread slots of cores 802. Usually a core 802 is associated with a first ISA, which defines/specifies instructions executable on core 802. Often machine code instructions that are part of the first ISA include a portion of the instruction (referred to as an opcode), which references/specifies an instruction or operation to be performed. The decode logic may include circuitry that recognizes these instructions from their opcodes and passes the decoded instructions on in the pipeline for processing as defined by the first ISA. For example, as decoders may, in one embodiment, include logic designed or adapted to recognize specific instructions, such as transactional instructions. As a result of the recognition by the decoders, the architecture of core 802 takes specific, predefined actions to perform tasks associated with the appropriate instruction. It is important to note that any of the tasks, blocks, operations, and methods described herein may be performed in response to a single or multiple instructions; some of which may be new or old instructions. Decoders of cores 802, in one embodiment, recognize the same ISA (or a subset thereof). Alternatively, in a heterogeneous core environment, a decoder of one or more cores (e.g., core 802B) may recognize a second ISA (either a subset of the first ISA or a distinct ISA).

In various embodiments, cores 802 may also include one or more arithmetic logic units (ALUs), floating point units (FPUs), caches, instruction pipelines, interrupt handling hardware, registers, or other suitable hardware to facilitate the operations of the cores 802.

Bus 808 may represent any suitable interconnect coupled to CPU 812. In one example, bus 808 may couple CPU 812 to another CPU of platform logic (e.g., via UPI). I/O blocks 804 represents interfacing logic to couple I/O devices 810 and 815 to cores of CPU 812. In various embodiments, an I/O block 804 may include an I/O controller that is integrated onto the same package as cores 802 or may simply include interfacing logic to couple to an I/O controller that is located off-chip. As one example, I/O blocks 804 may include PCIe interfacing logic. Similarly, memory controller 806 represents interfacing logic to couple memory 814 to cores of CPU 812. In various embodiments, memory controller 806 is integrated onto the same package as cores 802. In alternative embodiments, a memory controller could be located off chip.

As various examples, in the embodiment depicted, core 802A may have a relatively high bandwidth and lower latency to devices coupled to bus 808 (e.g., other CPUs 812) and to NICs 810, but a relatively low bandwidth and higher latency to memory 814 or core 802D. Core 802B may have relatively high bandwidths and low latency to both NICs 810 and PCIe solid state drive (SSD) 815 and moderate bandwidths and latencies to devices coupled to bus 808 and core 802D. Core 802C would have relatively high bandwidths and low latencies to memory 814 and core 802D. Finally, core 802D would have a relatively high bandwidth and low latency to core 802C, but relatively low bandwidths and high latencies to NICs 810, core 802A, and devices coupled to bus 808.

“Logic” (e.g., as found in I/O controllers, power managers, latency managers, etc. and other references to logic in this application) may refer to hardware, firmware, software and/or combinations of each to perform one or more functions. In various embodiments, logic may include a microprocessor or other processing element operable to execute software instructions, discrete logic such as an application specific integrated circuit (ASIC), a programmed logic device such as a field programmable gate array (FPGA), a memory device containing instructions, combinations of logic devices (e.g., as would be found on a printed circuit board), or other suitable hardware and/or software. Logic may include one or more gates or other circuit components. In some embodiments, logic may also be fully embodied as software.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software-based hardware models, and HDL and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of system on chip (SoC) and other hardware device. In some instances, the HDL object can be used as the basis for developing models and design files that can be used by manufacturing equipment to manufacture the described hardware. Indeed, an HDL object itself can be provided as an input to manufacturing system software to cause the described hardware.

In any representation of the design, the data may be stored in any form of a machine readable medium. A memory or a magnetic or optical storage such as a disc may be the machine-readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 418A0 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, e.g., reset, while an updated value potentially includes a low logical value, e.g., set. Note that any combination of values may be utilized to represent any number of states.

The embodiments of methods, hardware, software, firmware, or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

The following examples pertain to embodiments in accordance with this Specification. Example 1 is an apparatus including: circuitry to implement a input/output (I/O) function; a memory; and protocol circuitry to: implement, in the memory, a doorbell queue to receive a work submission indicator from a host device, where the work submission indicator identifies a work request associated with the I/O function; implement a logger queue in the memory to store a copy of the work submission indicator, where the logger queue is to store copies of a stream of work submission indicators as the stream of indicators are written to the doorbell queue, where the stream of work submission indicators includes the work submission indicator; identify, based on the logger queue, that a threshold amount of work submission indicators are written to the doorbell queue; and freeze the logger queue based on the threshold amount, where the doorbell queue is to continue to receive work submission indicators while the logger queue is frozen.

Example 2 includes the subject matter of example 1, where the work submission indicator points to a location in memory of the host device where the work request is stored.

Example 3 includes the subject matter of any one of examples 1-2, where the doorbell queue buffers work submission indicators to be written to a doorbell register, and the doorbell queue includes a first-in-first-out (FIFO) queue.

Example 4 includes the subject matter of example 3, where the doorbell queue buffers work submission indicators addressed to a plurality of doorbell registers to be implemented in the memory.

Example 5 includes the subject matter of any one of examples 1-4, where the logger queue, when frozen, allows contents of the logger queue to be accessed to determine a cause of the threshold amount of work submission indicators.

Example 6 includes the subject matter of example 5, further including: a processor; and a controller executable by the processor to: determine the cause of the threshold amount; and initiate a mitigation of the cause.

Example 7 includes the subject matter of example 5, where the host device hosts a plurality of tenants, the plurality of tenants submit work submission indicators in the stream of work submission indicators corresponding to work requests by the plurality of tenants, and the cause is determined to originate with a particular one of the plurality of tenants based on the contents of the logger queue.

Example 8 includes the subject matter of any one of examples 1-7, where the work request corresponds to a virtualization of the I/O function for a tenant hosted on the host device.

Example 9 includes the subject matter of example 8, where the virtualization includes a Single Root I/O Virtualization (SR-IOV) with the I/O function mapped to a function.

Example 10 includes the subject matter of example 8, where the virtualization includes a Scalable I/O Virtualization (SIOV) with the I/O function mapped to an assignable device interface (ADI).

Example 11 includes the subject matter of any one of examples 1-10, where the threshold amount includes one of a threshold number of work submission indicators, a threshold capacity of the doorbell queue, or a rate of work submission indicators received at the doorbell queue.

Example 12 is a non-transitory machine-readable storage medium with instructions stored thereon, the instructions executable by a machine to cause the machine to: monitor a logger queue on an I/O device, where the logger queue mirrors entries written to a doorbell queue on the I/O device, the entries in the doorbell queue include work submission indicators written by a host device coupled to the I/O device by a link, and the work submission indicators correspond to work requests by one or more tenants hosted on the host device to use resources of the I/O device; determine that a threshold amount of work submission indicators have been written based on contents of the logger queue; freeze the logger queue based on the threshold amount of work submission indicators; access contents of the logger queue when the logger queue is frozen; and determine a cause of the threshold amount of work submission indicators.

Example 13 includes the subject matter of example 12, where the cause is determined to be a particular one of the one or more tenants hosted on the host device.

Example 14 includes the subject matter of any one of examples 12-13, where the instructions are further executable to cause the machine to initiate a mitigation measure to reduce a rate of subsequent work submission indicators written to the doorbell queue.

Example 15 includes the subject matter of any one of examples 12-14, where the instructions are further executable to cause the machine to restart the logger queue after determining the cause of the threshold amount of work submission indicators, where the doorbell queue continues to receive work submission indicators while the logger queue is frozen.

Example 16 is a system including: a host system including a processor to execute one or more applications; an I/O device coupled to the host system by an interconnect, the I/O device including: circuitry to implement a input/output (I/O) function; a memory; and protocol circuitry to: implement, in the memory, a doorbell queue to receive a work submission indicator from the host system, where the work submission indicator identifies a work request from the one or more applications associated with the I/O function; implement a logger queue in the memory to store a copy of the work submission indicator, where the logger queue is to store copies of a stream of work submission indicators as the stream of indicators are written to the doorbell queue, where the stream of work submission indicators includes the work submission indicator; identify, based on the logger queue, that a threshold amount of work submission indicators are written to the doorbell queue; and freeze the logger queue based on the threshold amount, where the doorbell queue is to continue to receive work submission indicators while the logger queue is frozen

Example 17 includes the subject matter of example 16, where the host system executes a virtual machine and the one or more applications are to be run within the virtual machine, and the work request corresponds to virtualization of the I/O function for the virtual machine.

Example 18 includes the subject matter of any one of examples 16-17, where the host system is to write the work submission indicators to the doorbell queue over the link through a memory-mapped I/O (MMIO) write.

Example 19 includes the subject matter of any one of examples 16-18, where the I/O device includes an infrastructure processing unit (IPU).

Example 20 includes the subject matter of any one of examples 16-19, where the I/O function includes at least one of a compression, cryptography, graphics, networking acceleration, or machine learning acceleration function.

Example 21 includes the subject matter of any one of examples 16-20, where the work submission indicator points to a location in memory of the host device where the work request is stored.

Example 22 includes the subject matter of any one of examples 16-21, where the doorbell queue buffers work submission indicators to be written to a doorbell register, and the doorbell queue includes a first-in-first-out (FIFO) queue.

Example 23 includes the subject matter of example 22, where the doorbell queue buffers work submission indicators addressed to a plurality of doorbell registers to be implemented in the memory.

Example 24 includes the subject matter of any one of examples 16-23, where the logger queue, when frozen, allows contents of the logger queue to be accessed to determine a cause of the threshold amount of work submission indicators.

Example 25 includes the subject matter of example 24, where the I/O device further includes: a processor; and a controller executable by the processor to: determine the cause of the threshold amount; and initiate a mitigation of the cause.

Example 26 includes the subject matter of example 24, where the host device hosts a plurality of tenants, the plurality of tenants submit work submission indicators in the stream of work submission indicators corresponding to work requests by the plurality of tenants, and the cause is determined to originate with a particular one of the plurality of tenants based on the contents of the logger queue.

Example 27 includes the subject matter of any one of examples 16-26, where the work request corresponds to a virtualization of the I/O function for a tenant hosted on the host device.

Example 28 includes the subject matter of example 27, where the virtualization includes a Single Root I/O Virtualization (SR-IOV) with the I/O function mapped to a function.

Example 29 includes the subject matter of example 27, where the virtualization includes a Scalable I/O Virtualization (SIOV) with the I/O function mapped to an assignable device interface (ADI).

Example 30 includes the subject matter of any one of examples 16-29, where the threshold amount includes one of a threshold number of work submission indicators, a threshold capacity of the doorbell queue, or a rate of work submission indicators received at the doorbell queue.

Example 31 is a method including: monitoring a logger queue on an I/O device, where the logger queue mirrors entries written to a doorbell queue on the I/O device, the entries in the doorbell queue include work submission indicators written by a host device coupled to the I/O device by a link, and the work submission indicators correspond to work requests by one or more tenants hosted on the host device to use resources of the I/O device; determining that a threshold amount of work submission indicators have been written based on contents of the logger queue; freezing the logger queue based on the threshold amount of work submission indicators; accessing contents of the logger queue when the logger queue is frozen; and determining a cause of the threshold amount of work submission indicators.

Example 32 includes the subject matter of example 31, where the cause is determined to be a particular one of the one or more tenants hosted on the host device.

Example 33 includes the subject matter of any one of examples 31-32, further including initiating a mitigation measure to reduce a rate of subsequent work submission indicators written to the doorbell queue.

Example 34 includes the subject matter of any one of examples 31-33, further including restarting the logger queue after determining the cause of the threshold amount of work submission indicators, where the doorbell queue continues to receive work submission indicators while the logger queue is frozen.

Example 35 is a system including means to perform the method of any one of examples 31-34.

Example 36 includes the subject matter of example 35, where the means include the apparatus of any one of examples 1-11.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An apparatus comprising:
circuitry to implement a function;
a memory; and
protocol circuitry to:
implement, in the memory, a doorbell queue to receive a work submission indicator from a host device, wherein the work submission indicator identifies a work request associated with the I/O function;
implement a logger queue in the memory to store a copy of the work submission indicator, wherein the logger queue is to store copies of a stream of work submission indicators as the stream of indicators are written to the doorbell queue, wherein the stream of work submission indicators comprises the work submission indicator;
identify, based on the logger queue, that a threshold amount of work submission indicators are written to the doorbell queue; and
freeze the logger queue based on the threshold amount, wherein the doorbell queue is to continue to receive work submission indicators while the logger queue is frozen.

2. The apparatus of claim 1, wherein the work submission indicator points to a location in memory of the host device where the work request is stored.

3. The apparatus of claim 1, wherein the doorbell queue buffers work submission indicators to be written to a doorbell register, and the doorbell queue comprises a first-in-first-out (FIFO) queue.

4. The apparatus of claim 3, wherein the doorbell queue buffers work submission indicators addressed to a plurality of doorbell registers to be implemented in the memory.

5. The apparatus of claim 1, wherein the logger queue, when frozen, allows contents of the logger queue to be accessed to determine a cause of the threshold amount of work submission indicators.

6. The apparatus of claim 5, further comprising:
a processor; and
a controller executable by the processor to:
determine the cause of the threshold amount; and
initiate a mitigation of the cause.

7. The apparatus of claim 5, wherein the host device hosts a plurality of tenants, the plurality of tenants submit work submission indicators in the stream of work submission indicators corresponding to work requests by the plurality of tenants, and the cause is determined to originate with a particular one of the plurality of tenants based on the contents of the logger queue.

8. The apparatus of claim 1, wherein the work request corresponds to a virtualization of the function for a tenant hosted on the host device.

9. The apparatus of claim 8, wherein the virtualization comprises a Single Root I/O Virtualization (SR-IOV).

10. The apparatus of claim 8, wherein the virtualization comprises a Scalable I/O Virtualization (SIOV) with the function mapped to an assignable device interface (ADI).

11. The apparatus of claim 1, wherein the threshold amount comprises one of a threshold number of work submission indicators, a threshold capacity of the doorbell queue, or a rate of work submission indicators received at the doorbell queue.

12. The apparatus of claim 1, wherein function comprises an I/O function.

13. At least one machine-readable storage medium with instructions stored thereon, the instructions executable by a machine to cause the machine to:
monitor a logger queue on an I/O device, wherein the logger queue mirrors entries written to a doorbell queue on the I/O device, the entries in the doorbell queue comprise work submission indicators written by a host device coupled to the I/O device by a link, and the work submission indicators correspond to work requests by one or more tenants hosted on the host device to use resources of the I/O device;
determine that a threshold amount of work submission indicators have been written based on contents of the logger queue;
freeze the logger queue based on the threshold amount of work submission indicators;
access contents of the logger queue when the logger queue is frozen; and
determine a cause of the threshold amount of work submission indicators.

14. The storage medium of claim 12, wherein the cause is determined to be a particular one of the one or more tenants hosted on the host device.

15. The storage medium of claim 12, wherein the instructions are further executable to cause the machine to initiate a mitigation measure to reduce a rate of subsequent work submission indicators written to the doorbell queue.

16. The storage medium of claim 12, wherein the instructions are further executable to cause the machine to restart the logger queue after determining the cause of the threshold amount of work submission indicators, wherein the doorbell queue continues to receive work submission indicators while the logger queue is frozen.

17. A system comprising:
a host system comprising a processor to execute one or more applications;
an I/O device coupled to the host system by an interconnect, the I/O device comprising:
circuitry to implement a input/output (I/O) function;
a memory; and
protocol circuitry to:
implement, in the memory, a doorbell queue to receive a work submission indicator from the host system, wherein the work submission indicator identifies a work request from the one or more applications associated with the I/O function;
implement a logger queue in the memory to store a copy of the work submission indicator, wherein the logger queue is to store copies of a stream of work submission indicators as the stream of indicators are written to the doorbell queue, wherein the stream of work submission indicators comprises the work submission indicator;
identify, based on the logger queue, that a threshold amount of work submission indicators are written to the doorbell queue; and
freeze the logger queue based on the threshold amount, wherein the doorbell queue is to continue to receive work submission indicators while the logger queue is frozen

18. The system of claim 16, wherein the host system executes a virtual machine and the one or more applications are to be run within the virtual machine, and the work request corresponds to virtualization of the I/O function for the virtual machine.

19. The system of claim 16, wherein the host system is to write the work submission indicators to the doorbell queue over the link through a memory-mapped I/O (MMIO) write.

20. The system of claim 16, wherein the I/O function comprises at least one of a compression, cryptography, graphics, networking acceleration, or machine learning acceleration function.
